(19) United States
(12) Patent Application Publication
(10) Pub. No.: US 2008/0112706 A1
(43) Pub. Date: May 15, 2008

(54) Optical receiving apparatus and optical communication system using same

(75) Inventors: Hoon Kim, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/906,930

(22) Filed: Oct. 4, 2007

(30) Foreign Application Priority Data
Nov. 10, 2006 (KR) 111087/2006

(51) Int. Cl. H04J 14/02

(52) U.S. Cl. 398/91

(57) ABSTRACT

An optical receiving apparatus for reducing crosstalk in a WDM communication system is disclosed. The receiving device includes a wavelength division de-multiplexer for receiving and de-multiplexing a first multiplexed optical signal and a second multiplexed optical signal, a first receiver for photo-electrically converting the first optical signal input from the wavelength division de-multiplexer into a first data signal, a second receiver for photo-electrically converting the second optical signal input from the wavelength division de-multiplexer and dividing the photo-electrically converted signal into a first division signal and a second division signal according to power and a compensator for inversing the second division signal and combining the inversed signal with the first data signal, thereby generating a signal compensating for crosstalk.

### CLAIM OF PRIORITY

This application claims the benefit of the earlier filing date, under 35 U.S.C. §119(a), to that patent application entitled “Optical Receiving Apparatus and Optical Communication System Using the Same,” filed in the Korean Intellectual Property Office on Nov. 10, 2006 and assigned Serial No. 2006-111087, the contents of which are hereby incorporated by reference.

### BACKGROUND OF THE INVENTION

1. Field of the Invention

The present invention relates to an optical communication system of a Wavelength Division Multiplexing (WDM) scheme. More particularly, the present invention relates to an optical communication system of a WDM scheme, by which it is possible to compensate for crosstalk caused by Stimulated Raman Scattering (SRS).

2. Description of the Related Art

A WDM scheme is used to transmit a plurality of optical signals having mutually different wavelengths through a single optical fiber. The WDM scheme can achieve a large transmission capacity even with only a few optical fibers, so it is broadly used in optical subscriber networks, backbone networks, ultra long-haul optical network communication systems, etc. In the optical communication system of the WDM scheme, optical signals having mutually different wavelengths are simultaneously transmitted through a single optical fiber. Thus, crosstalk may occur among the optical signals. The SRS, the most significant factor causing crosstalk, results in degradation of performance of optical subscriber networks in addition to ultra long-haul optical communication system. In particular, when an analog signal (e.g. a cable television: CATV) and a digital signal are simultaneously transmitted through a single optical fiber, degraded quality of the CATV signals by the SRS has emerged as a major issue. In the case of digital signals, it is relatively easy to detect and eliminate a component of crosstalk.

Hereinafter, the phenomenon of crosstalk, which may be caused by the SRS, will be briefly discussed. When a first optical signal having a short wavelength and a second optical signal having a long wavelength are simultaneously transmitted through an optical fiber, the first optical signal functions as a pump light for the optical fiber, so that the second optical signal may obtain a gain. The gain value is determined by the intensities of the first and second optical signals, a degree of polarization overlap, a wavelength interval, and a Raman gain characteristic of the optical fiber, etc. In addition, when the first optical signal is modulated, the gain that the second optical signal obtains has time-varying characteristics according to changes in power of the first optical signal. The occurrence of such a time-varying gain implies the occurrence of crosstalk. In addition, the waveform of the second optical signal has a shape resulting from an overlap of a component of an original waveform with that of a waveform caused by the crosstalk. The waveform caused by the crosstalk has a shape similar to that of the second modulated optical signal. When the second optical signal is modulated, the first optical signal is also influenced by crosstalk. This is known as a phenomenon of pump-depletion caused by changes in the intensity of the second optical signal.

The conventional methods for reducing SRS crosstalk include a first method of reducing a wavelength interval between a first optical signal and a second optical signal, and a second method of adding an optical signal having a waveform opposite to that of an optical signal causing crosstalk to the optical signal causing crosstalk.

The first method is based on the fact that crosstalk caused by the SRS is reduced if a wavelength interval between a first optical signal and a second optical signal is reduced. Most optical fibers have a characteristic in that the Raman gain lineally increases as a wavelength interval increases within a wavelength interval of 12 THz. Therefore, SRS crosstalk decreases according to reduction of the wavelength interval. However, a phenomenon of cross-phase modulation (XPM) prominently appears according to reduction of a wavelength interval. Moreover, crosstalk lineally increases in a wavelength division de-multiplexer, so that there is a limit in reducing the wavelength interval.

Hereinafter, the second method will be described with reference to the accompanying drawings.

FIG. 1 is a view illustrating a conventional optical communication system of a WDM scheme where compensation for the crosstalk caused by the SRS is possible. The optical communication system 100 includes an optical transmitting apparatus 110 and an optical receiving apparatus 150, which are connected with each other through at least one optical fiber 145.

The optical transmitting apparatus 110 includes transmitters 120, 130, and 135 (TX) for electro-optical conversion, a Wavelength Division Multiplexer (WDM) 140 for multiplexing, a divider 115 for power division, and an inverse amplifier 125 for inverse amplification. The first transmitter 120 is used to transmit an analog data signal, such as a CATV signal, and the third transmitter 135 is used to transmit a digital data signal, such as an Ethernet signal.

The divider 115 divides the first input data signal S1 into equal parts according to power, thereby generating and outputting first and second division signals S1a and S3. The first transmitter 120 electro-optically converts the first division signal S1a input from the divider 115 into a first optical signal S1b having a first wavelength, and outputs the resulting signal. The inverse amplifier 125 inversely amplifies the second division signal S3 input from the divider 115 and outputs the resulting signal. The second transmitter 130 electro-optically converts the inversely amplified signal input from the inverse amplifier 125 into a third optical signal S3b having a third wavelength, and outputs the resulting signal. The third transmitter 135 electro-optically converts the second input data signal S2 into a second optical signal S2a having a second wavelength, and outputs the resulting signal. In this case, the first data signal S1 is a CATV signal and the second data signal S2 is a digital data signal. The second wavelength is a middle wavelength between a first wavelength (e.g., a short wavelength) and a third wavelength (e.g., a long wavelength). The wavelength division multiplexer 140 multiplexes the first to third optical signals S1b, S2a, and S3b, input from the first to third transmitters 120, 130, and 135, according to a wavelength and outputs the multiplexed signal.

FIGS. 2A to 2C are graphs illustrating the relationship of the first and third optical signals S1b and S3b. FIG. 2A shows an intensity of the first optical signal S1b based on the time axis, FIG. 2B shows an intensity of the third optical signal S3b based on the time axis, and FIG. 2C shows a composite intensity of the first and third optical signals S1b and S3b. It is clear from FIGS. 2A to 2C that the third optical signal S3b has an inverse waveform relative to a waveform of the first optical signal S1b.

While passing through the optical fiber 145, the second optical signal S2a undergoes the SRS crosstalk caused by the first optical signal S1b and pump-depletion crosstalk caused by the third optical signal S3b. In this case, the components of SRS crosstalk and pump-depletion crosstalk cancel each other, so that the second optical signal S2a has only the original signal components without the crosstalk.

In the preceding statement, it is exemplified that the second wavelength is a middle wavelength between a first wavelength (i.e. a short wavelength) and a third wavelength (i.e. a long wavelength). However, the third wavelength may be used as the middle wavelength between a first wavelength (i.e. a short wavelength) and a second wavelength (i.e. a long wavelength).

In this case, while passing through the optical fiber 145, the second optical signal S2a undergoes the SRS crosstalk caused by the first optical signal S1b and the third optical signal S3b, so that respective SRS crosstalk cancel each other. Therefore, the second optical signal S2a may have only the original signal components without the crosstalk.

The optical receiving apparatus 150 receives the first and second multiplexed optical signals S1b and S2a through the optical fiber 145, and a wavelength division de-multiplexer (WDM) 155 for de-multiplexing, and first and second receivers 160 and 170 (RX) for photo-electrical conversion.

The wavelength division de-multiplexer 155 de-multiplexes the first and second multiplexed optical signals S1b and S2a, which are input through the optical fiber 145, and outputs the resulting signal. In this case, the third optical signal S3b is interrupted and eliminated by the wavelength division de-multiplexer 155. Since a general wavelength division multiplexer, such as an arrayed waveguide grating, has reversibility, it can perform wavelength division multiplexing/de-multiplexing. Therefore, it is usual to commonly mark both the wavelength division multiplexer and the wavelength division de-multiplexer as a WDM.

The first receiver 160 includes a first photo diode (PD) 165, which restores a first data signal S1c from signals obtained by photo-electrically converting the first optical signal S1b input from wavelength division de-multiplexer 155.

The second receiver 170 includes a second photo diode 172 and a clock/data recovery circuit (CDR) 174. The second photo diode 172 photo-electrically converts the second optical signal S2a input from wavelength division de-multiplexer 155, and clock/data recovery circuit 174 restores a second data signal S2c from photo-electrically converted signal S2b and then outputs the resulting signal.

However, the optical communication system as described above requires an additional light source to compensate for crosstalk. Further, in the optical communication system as described above, a walk-off phenomenon may occur between the first and third optical signals due to dispersion of an optical fiber, thereby increasing dispersion. Therefore, in the optical communication system described above, it is difficult to compensate for crosstalk.

### SUMMARY OF THE INVENTION

Accordingly, the present invention has been made to provide an optical receiving apparatus and an optical communication system using same that can compensate for SRS crosstalk without requiring a separate light source.

In accordance with an aspect of the present invention, there is provided an optical receiving apparatus including a wavelength division de-multiplexer for receiving and de-multiplexing a first multiplexed optical signal and a second multiplexed optical signal, a first receiver for photo-electrically converting the first optical signal input from the wavelength division de-multiplexer into a first data signal, a second receiver for photo-electrically converting the second optical signal input from the wavelength division de-multiplexer and dividing the photo-electrically converted signal into a first division signal and a second division signal according to power and a compensator for inversing the second division signal and combining the inversed signal with the first data signal.

In accordance with another aspect of the present invention, there is provided an optical communication system including an optical transmitting apparatus for transmitting a first optical signal and a second optical signal; and an optical receiving apparatus for receiving the first and second optical signals from the optical transmitting apparatus through an optical fiber, wherein the optical receiving apparatus comprises a wavelength division de-multiplexer for receiving and de-multiplexing a first multiplexed optical signal and a second multiplexed optical signal; a first receiver for photo-electrically converting the first optical signal input from the wavelength division de-multiplexer into a first data signal, a second receiver for photo-electrically converting the second optical signal input from the wavelength division de-multiplexer and dividing the photo-electrically converted signal into a first division signal and a second division signal according to power and a compensator for inversing the second division signal and combining the inversed signal with the first data signal, thereby generating a signal obtained by compensating for crosstalk.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view illustrating an optical communication system of a WDM scheme compensating for SRS crosstalk;

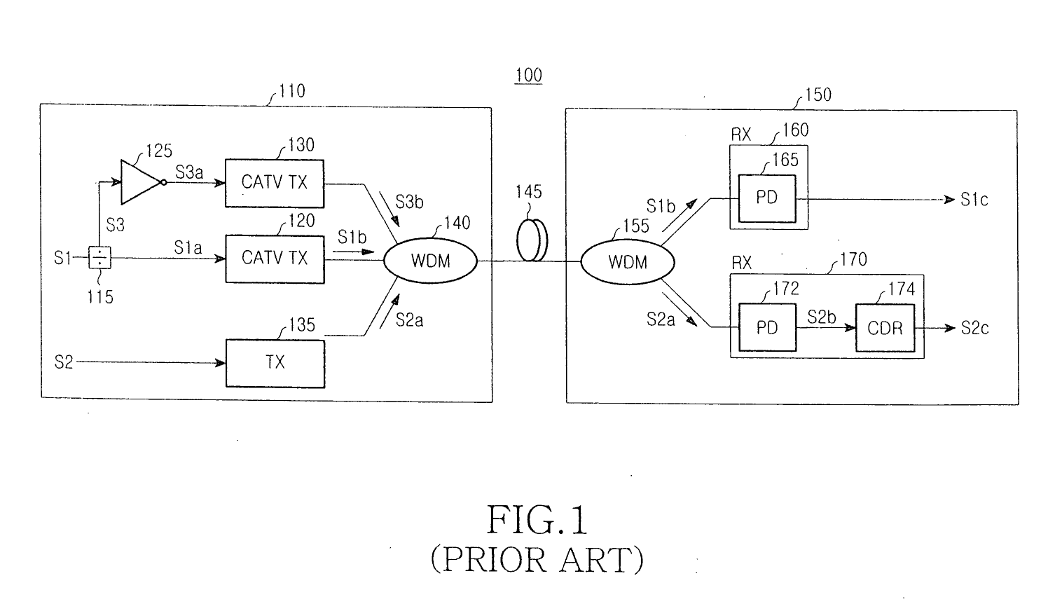

FIGS. 2A to 2C are graphs illustrating the relationship of the first and third optical signals which are shown in FIG. 1;

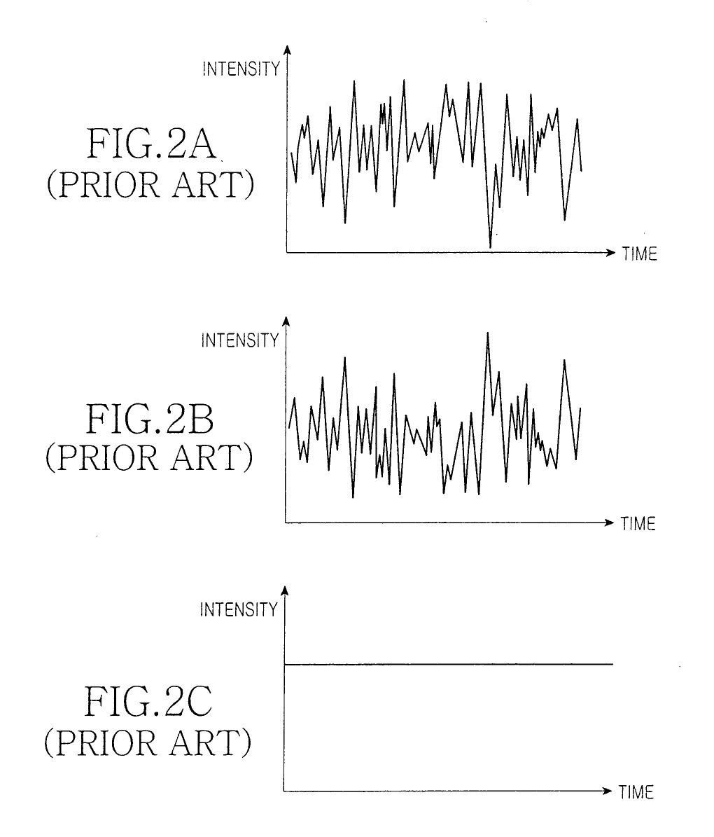

FIG. 3 is a view illustrating an optical communication system of a WDM scheme according to an embodiment of the present invention; and

FIG. 4 is a graph illustrating change in the amount of the crosstalk according to the polarization scrambling frequency.

### DETAILED DESCRIPTION OF THE INVENTION

Now, embodiments of the present invention will be described with reference to the accompanying drawings. For the purposes of clarity and simplicity, a detailed description of known functions and configurations incorporated herein will be omitted as it may make the subject matter of the present invention rather unclear.

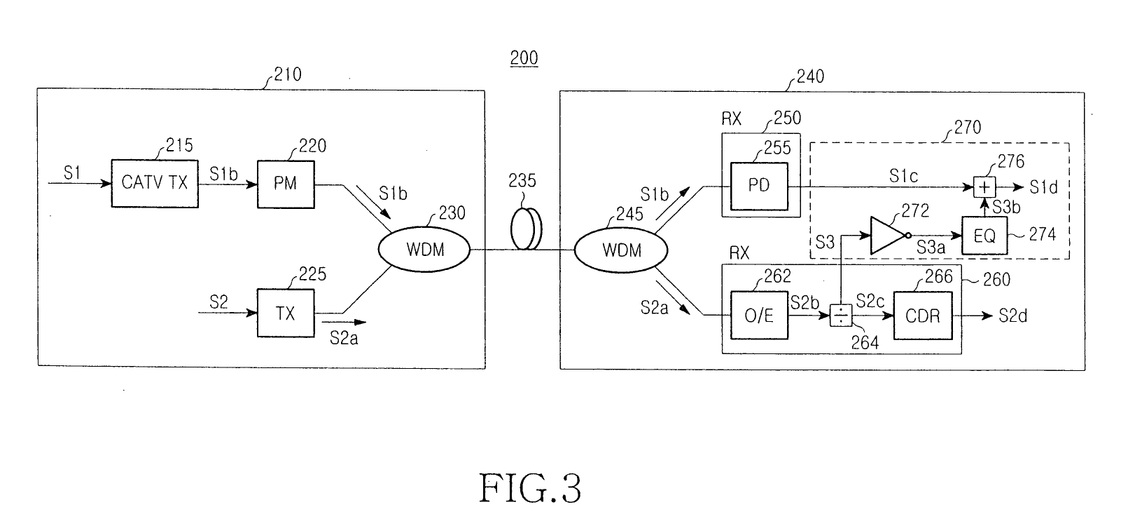

FIG. 3 is a view illustrating an optical communication system of a WDM scheme according to an embodiment of the present invention. The optical communication system 200 includes an optical transmitting apparatus 210 and an optical receiving apparatus 240, which are connected with each other through optical fiber 235.

The optical transmitting apparatus 210 includes first and second transmitters 215 and 225 (TX) for electro-optical conversion, a polarization modulator 220 (PM) for polarization scrambling, and a wavelength division multiplexer 230 for multiplexing. The first transmitter 215 is used to transmit an analog data signal, such as a CATV signal, and the second transmitter 225 is used to transmit a digital data signal, such as an Ethernet signal.

The first transmitter 215 electro-optically converts a first input data signal S1 into a first optical signal S1a having a first wavelength, and outputs the resulting signal.

The second transmitter 225 electro-optically converts a second input data signal S2 into a second optical signal S2a having a second wavelength, i.e. modulates a second input data signal S2 into a second optical signal S2a having a second wavelength, and outputs the resulting signal. The first data signal S1 may, for example, be a CATV signal, the second data signal S2 is a digital data signal, the first wavelength is a long wavelength, and the second wavelength is a short wavelength. Each of the first and second transmitters 215 and 225 may include either a Laser Diode (LD), which directly performs modulation, or a combination of external modulators such as a Continuous Wave Laser Diode (CW-LD), a Mach-Zehnder modulator.

The polarization modulator 220 polarizes the first optical signal S1a, which is input from the first transmitter 215. Thus, the modulator 220 performs polarization scrambling so as to reduce the degree of polarization of the first optical signal S1a. In other words, the polarization modulator 220 flattens the intensity distribution for all polarization states. That is, when the whole intensity concentrates in a single polarization state (e.g., linear polarization), the degree of polarization is 100%. In contrast, when all polarization states show the same intensity (e.g., in the case of non-polarized light such as a natural light or in the case of circular polarization), the degree of polarization is 0%. Such a polarization modulator is called a polarization scrambler. An example of a polarization scrambler using an optical fiber is disclosed in U.S. Pat. No. 4,923,290, entitled “POLARIZATION SCRAMBLER,” issued to Brinkmeyer, et al.

The amount of the crosstalk caused by SRS is changed according to the degree of polarization overlap. When the optical fiber 235 has polarization mode dispersion, the degree of polarization overlap is influenced by factors such as temperature of the optical fiber 235, or pressure of the optical fiber 235, caused by change of the external environment. The polarization modulator 220 modulates a polarization state of the first optical signal S1a, so that the degree of the polarization overlap can be maintained substantially constant regardless of change in the external environment. In this case, the polarization modulation is performed so that the effect of the polarization modulation on recovery (i.e. demodulation) of the first data signal S1 can be minimized. In another aspect, it is possible to easily eliminate noise on a specific polarization state, which may occur while the first polarization-scrambled optical signal S1b passes through a polarization dependent element, by using a polarization filter.

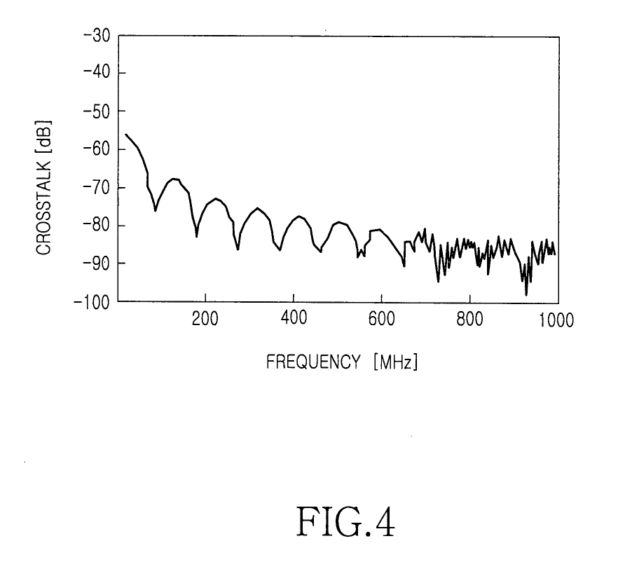

FIG. 4 is a graph illustrating the change in the amount of the crosstalk according to the polarization scrambling frequency. FIG. 4 illustrates that the amount of the crosstalk is reduced according to an increase in the polarization scrambling frequency. In the present embodiment, the power of the crosstalk component (i.e. amount of the crosstalk) occurring on the first polarization scrambled optical signal S1b was measured while the modulation frequency (i.e. the polarization scrambling frequency) of the polarization modulator 220 was changed. In this case, the first polarization scrambled optical signal S1b has a wavelength of 1550 nm, the second polarization scrambled optical signal S2a has a wavelength of 1532 nm, and the first and second polarization scrambled optical signals S1b and S2a pass through the optical fiber 235 having a length of 30 km.

The wavelength division multiplexer 230 multiplexes the first and second polarization scrambled optical signals S1b and S2a input from the polarization modulator 220 and a second transmitter 225, according to a wavelength and then outputs the resulting signal. An arrayed waveguide grating, a Y-Branch Waveguide, and a star coupler, etc. may also be used as the wavelength division multiplexer 230.

While passing through the optical fiber 235, the first polarization scrambled optical signal S1b undergoes the SRS crosstalk by the second optical signal S2a. The second optical signal S2a also undergoes pump-depletion crosstalk by the first polarization scrambled optical signal S1b. However, the present embodiment does not take the pump-depletion crosstalk into consideration, because the second optical signal S2a is a digital signal.

The optical receiving apparatus 240 receives the first and second multiplexed optical signals S1b and S2a, which are polarization scrambled, through the optical fiber 235. The optical receiving apparatus 240 includes a wavelength division de-multiplexer 245 for de-multiplexing the received signals, first and second receivers 250 and 260 (RX) for photo-electrical conversion, and a compensator 270 for compensation for crosstalk.

The wavelength division de-multiplexer 245 receives the first and second multiplexed optical signals S1b and S2a through the optical fiber 235 for de-multiplexing, the signals being polarization scrambled, and outputs the resulting signal. An arrayed waveguide grating, a directional coupler, etc. may be used as the wavelength division de-multiplexer 245.

The first receiver 250 includes a first optical-to-electrical converter 255, wherein the first optical-to-electrical converter 255 photo-electrically converts the first polarization-scrambled optical signal S1b input from the wavelength division de-multiplexer 245, thereby restoring (i.e. demodulating) first data signal S1c. Converter 255 may be a photo-diode (PD).

The second receiver 260 includes a second optical-to-electrical converter 262, a divider 264, and a clock/data recovery circuit 266.

The second optical-to-electrical converter 262 photo-electrically converts a second optical signal S2a input from the wavelength division de-multiplexer 245 and outputs a photo-electrically converted signal S2b. A photodiode may be used as the first or second optical-to-electrical converters 255 or 262.

The divider 264 divides the photo-electrically converted signal S2b, which is input from the second optical-to-electrical converter 262, into equal parts according to power, thereby generating and outputting first and second division signals S2c and S3. A general power divider, etc. may be used as the divider 264.

The clock/data recovery circuit 266 restores a second data signal S2d from the first division signal S2c input from the divider 264 and outputs the resulting signal. Also, the clock/data recovery circuit 266 restores a clock signal together with the second data signal S2d. Since such a clock/data recovery circuit is generally used, detail description with respect to this will be omitted herein.

The compensator 270 includes an inverse amplifier 272, an equalizer (EQ) 274, and a combiner 276.

The inverse amplifier 272 inversely amplifies the second division signal S3 input from the divider 264, according to a preset gain and outputs the resulting signal. In this case, the gain of the inverse amplifier 272 is set so that the first restored data signal S1c can be cancelled by an inversely amplified signal S3a.

The equalizer 274 attenuates the inversely amplified signal S3a input from the inverse amplifier 272 and outputs the resulting signal. In this case, the attenuation rate of the equalizer 274 is determined according to the polarization scrambling frequency, and the attenuation rate of the equalizer 274 is set to eliminate the deviation in the amount of the crosstalk depending on the polarization scrambling frequency. As shown in FIG. 4, the amount of the crosstalk is reduced according to an increase in the polarization scrambling frequency. Therefore, the attenuation rate of the equalizer 274 is set to gradually decrease according to the increase in the polarization scrambling frequency.

The combiner 276 combines the first restored data signal S1c input from the first optical-to-electrical converter 255 with the attenuated signal S3b input from the equalizer 274, thereby generating and outputting a signal S1d obtained by compensating for crosstalk.

The present invention as described above provides an optical receiving apparatus and an optical communication system using same, which can compensate for crosstalk by using an inverse amplifier, without requiring a separate light source.

While the invention has been shown and described with reference to certain an exemplary embodiment thereof, it will be understood by those skilled in the art that various changes in form and details may be made therein without departing from the spirit and scope of the invention as defined by the appended claims.

What is claimed is:

1. An optical receiving apparatus comprising:
a wavelength division de-multiplexer for receiving and de-multiplexing a first multiplexed optical signal and a second multiplexed optical signal;
a first receiver for photo-electrically converting the first optical signal input from the wavelength division de-multiplexer into a first data signal;
a second receiver for photo-electrically converting the second optical signal input from the wavelength division de-multiplexer and dividing the photo-electrically converted signal into a first division signal and a second division signal according to power; and
a compensator for inversing the second division signal and combining the inversed signal with the first data signal, thereby generating a crosstalk compensated signal.

2. The optical receiving apparatus as claimed in claim 1, wherein the second receiver comprises:
an optical-to-electrical converter for photo-electrically converting the second optical signal input from the wavelength division de-multiplexer;
a divider for dividing the photo-electrically converted signal input from the optical-to-electrical converter into equal parts, according to power, thereby generating and outputting first and second division signals; and
a data recovery circuit for restoring a second data signal from the division signal input from the divider and outputting the restored signal.

3. The optical receiving apparatus as claimed in claim 1, wherein the compensator comprises:
an inverse amplifier for inversely amplifying the second division signal input from the second receiver, according to a preset gain and outputting the amplified signal;
an equalizer for attenuating the inversely amplified signal input from the inverse amplifier and outputting the attenuated signal; and
a combiner for combining the first data signal input from the first receiver with the attenuated signal input from the equalizer, thereby generating and outputting a signal obtained by compensating for crosstalk.

4. The optical receiving apparatus as claimed in claim 3, wherein the first optical signal is polarization scrambled, and the attenuation rate of the equalizer is set to gradually decrease according to an increase in the polarization scrambling frequency.

5. The optical receiving apparatus as claimed in claim 1, wherein the first optical signal is an analog signal having a long wavelength, and the second optical signal is a digital signal having a short wavelength.

6. An optical communication system comprising:
an optical transmitting apparatus for transmitting a first optical signal and a second optical signal; and
an optical receiving apparatus for receiving the first and second optical signals from the optical transmitting apparatus through an optical fiber,
wherein the optical receiving apparatus comprises:
a wavelength division de-multiplexer for receiving and de-multiplexing a first multiplexed optical signal and a second multiplexed optical signal;
a first receiver for photo-electrically converting the first optical signal input from the wavelength division de-multiplexer into a first data signal;
a second receiver for photo-electrically converting the second optical signal input from the wavelength division de-multiplexer and dividing the photo-electrically converted signal into a first division signal and a second division signal, according to power; and
a compensator for inversing the second division signal and combining the inversed signal with the first data signal, thereby generating a signal obtained by compensating for crosstalk.

7. The optical communication system as claimed in claim 6, wherein the second receiver comprises:
an optical-to-electrical converter for photo-electrically converting the second optical signal input from the wavelength division de-multiplexer;
a divider for dividing the photo-electrically converted signal input from the optical-to-electrical converter into equal parts, according to power, thereby generating and outputting first and second division signals; and
a data recovery circuit for restoring a second data signal from the first division signal input from the divider and outputting the restored signal.

8. The optical communication system as claimed in claim 6, wherein the compensator comprises:
an inverse amplifier for inversely amplifying the second division signal input from the second receiver, according to a preset gain and outputting the amplified signal;
an equalizer for attenuating the inversely amplified signal input from the inverse amplifier and outputting the attenuated signal; and
a combiner for combining the first data signal input from the first receiver with the attenuated signal input from the equalizer.

9. The optical communication system as claimed in claim 8, wherein the first optical signal is polarization scrambled and the attenuation rate of the equalizer is set to gradually decrease according to an increase in the polarization scrambling frequency.

10. The optical communication system as claimed in claim 6, wherein the first optical signal is an analog signal having a long wavelength, and the second optical signal is a digital signal having a short wavelength.

11. The optical communication system as claimed in claim 6, wherein the optical transmitting apparatus comprises:
a first transmitter for electro-optically converting a first data signal into a first optical signal and outputting the resulting signal;
a second transmitter for electro-optically converting a second data signal into a second optical signal and outputting the resulting signal;
a polarization modulator for subjecting the first optical signal to polarization scrambling and outputting the resulting signal; and
a wavelength division multiplexer for multiplexing the first and second polarization scrambled optical signals input from the polarization modulator and the second transmitter, according to a wavelength, and outputting the resulting signal.

12. An optical transmitting apparatus comprising:
a first transmitter for electro-optically converting a first data signal into a first optical signal and outputting the resulting signal;
a second transmitter for electro-optically converting a second data signal into a second optical signal and outputting the resulting signal;
a polarization modulator for subjecting the first optical signal to polarization scrambling and outputting the resulting signal; and
a wavelength division multiplexer for multiplexing the first optical signal and the second polarization scrambled optical signal, according to a wavelength, and outputting the resulting signal.

13. An optical receiving apparatus for receiving first and second optical signals through an optical fiber comprising:
a wavelength division de-multiplexer for receiving and de-multiplexing a first optical signal and a second optical signal;
a first receiver for photo-electrically converting the first optical signal input from the wavelength division de-multiplexer into a first data signal;
a second receiver for photo-electrically converting the second optical signal input from the wavelength division de-multiplexer and dividing the photo-electrically converted signal into a first division signal and a second division signal, according to power; and
a compensator for inversing the second division signal and combining the inverted signal with the first data signal, thereby generating a crosstalk compensated signal.

14. The apparatus as claimed in claim 13, wherein the second receiver comprises:
an optical-to-electrical converter for photo-electrically converting the second optical signal input from the wavelength division de-multiplexer;
a divider for dividing the photo-electrically converted signal input from the optical-to-electrical converter into equal parts, according to power, thereby generating and outputting first and second division signals; and
a data recovery circuit for restoring a second data signal from the first division signal input from the divider and outputting the restored signal.

15. The apparatus as claimed in claim 14, wherein the compensator comprises:
an inverse amplifier for inversely amplifying the second division signal input from the second receiver, according to a preset gain and outputting the amplified signal;
an equalizer for attenuating the inversely amplified signal input from the inverse amplifier and outputting the attenuated signal; and
a combiner for combining the first data signal input from the first receiver with the attenuated signal input from the equalizer.

16. The apparatus as claimed in claim 15, wherein the first optical signal is polarization scrambled and the attenuation rate of the equalizer is set to gradually decrease according to an increase in the polarization scrambling frequency.

17. The apparatus as claimed in claim 13, wherein the first optical signal is an analog signal having a long wavelength, and the second optical signal is a digital signal having a short wavelength.

18. The apparatus as claimed in claim 14, wherein said optical-to-electric converter comprises:
a photo-detector.

19. The apparatus as claimed in claim 14, wherein said divider comprises:
a power divider.

20. The apparatus as claimed in claim 16, wherein said equalizer attenuation rater is determined according to the polarization scrambling frequency.
